(19) United States
(12) Patent Application Publication
(10) Pub. No.: US 2019/0129723 A1
(43) Pub. Date: May 2, 2019

(54) PERVASIVE COMPUTING OPERATING SYSTEM PROTOTYPE BASED ON AGENTS

(71) Applicant: Shanghai DataCenter Science Co., LTD, Shanghai (CN)

(72) Inventors: Jun ZHANG, Shanghai (CN); Yong Fang, Wuxi City (CN); Bin Wang, Shanghai (CN)

(21) Appl. No.: 15/984,527

(22) Filed: May 21, 2018

(30) Foreign Application Priority Data
Nov. 1, 2017 (CN) 201711040394.3

(51) Int. Cl. G06F 9/4401; G06N 5/04

(52) U.S. Cl. CPC G06F 9/4406; G06N 5/043

(57) ABSTRACT

The present invention discloses a pervasive computing operating system prototype based on agents. The architecture comprises: perceiving the change of a pervasive environment through an information node; indexing and retrieving, by a context retriever the stored context information; providing services for the information node monitor and the context retriever through an interpreter; using a related main body for self-adaptive management when change of a context is retrieved; reasoning a high-level context according to the related main body in a cloud knowledge base; and providing to an effector to act on the pervasive environment through a multi-agent communication system. A pervasive computing operating system prototype based on agents is built.

### TECHNICAL FIELD

The present invention relates to a pervasive computing operating system prototype based on agents.

### BACKGROUND

Pervasive computing refers to ubiquitous computing. Context perceptual computing has become a core research topic in pervasive computing projects. Context is information which can be used to describe situations of an entity. The entity may be a person, a place or an object that interacts between a user and an application program, including the user and the application program. If whether a system conducts context perception depends on whether the system provides relevant information and services for the user based on context information, relevance depends on tasks of the user.

In a pervasive computing environment, the system must perceive context information which is changed dynamically and take corresponding actions. Therefore, to satisfy these requirements, perception and development of the application program shall be separated, i.e., low-level perception data processing and high-level context perception application program shall be separated. A layered structure is introduced into context perception and used to avoid low-level perception details and provide necessary context perception services for the application program.

The concept of a knowledge base comes from two different fields. The first field is the field of artificial intelligence and its branch-knowledge engineering, and the other field is a traditional database field. Generation and development of a knowledge base system are facilitated through organic combination of two computer technologies: artificial intelligence and database. However, pressure is brought to control due to the lack of intelligent means, passive adaptation, low efficiency and massive computation.

A main body means approval for sharable concepts, and supplies the same understanding from expression to practical semantic connotation. These concepts include many conceptual frameworks, and can model the knowledge of different application fields and appoint application-related communication rules.

A multi-agent system belongs to the research field of distributed artificial intelligence of an artificial intelligence discipline. The multi-agent system is a system composed of multiple interactive agent systems, and has the features of distributivity, cooperativity, parallelism and the like of a typical complex system. Multi-agent technology discusses that a group of autonomous agent systems, assembled under a dynamic open environment, complete complicated system control and task solving process through interaction, cooperation, competition, consultation, etc.

Each agent has a clear objective, and communicates with other agents by perceiving self internal state and environment information in the environment to improve respective reasoning and control capabilities so as to complete problem solving. The multi-agent system can weaken the limitations on centralized control, planning and sequence control, provide the functions of decentralized control, emergency and parallel treatment and the like, reduce consumption of software or hardware and provide more convenient problem solving.

In the multi-agent system, the agents make decisions and take actions by coordinating their knowledge, objectives, skills and plans. In a multi-agent information integration system, each agent may have expert knowledge of different fields and different decision functions, and can observe different times and spaces, different aspects and different characteristics in the environment.

The operating system is a program which controls the execution of the application program, and is used as an interface between the application program and computing hardware. The operating system provides another layer of abstraction for use hardware, and has the tasks of creating abstraction and realizing and managing abstract objects created by the operating system. Distribution for a processor, a memory and other I/O interfaces are controlled in an orderly manner among competing programs.

The present invention provides a pervasive computing operating system prototype based on agents. The architecture comprises: perceiving the change of a pervasive environment through an information node; indexing and retrieving, by a context retriever the stored context information; providing services for the information node monitor and the context retriever through an interpreter; using a related main body for self-adaptive management when change of a context is retrieved; reasoning a high-level context according to the related main body in a cloud knowledge base; and providing to an effector to act on the pervasive environment through a multi-agent communication system. A pervasive computing operating system prototype based on agents is built.

### SUMMARY

The purpose of the present invention is to provide a pervasive computing operating system prototype based on agents. The present invention has the following features:

Technical Solution of the Invention

1. A pervasive computing operating system architecture based on agents, comprising:

1) perceiving the change of a pervasive environment through an information node;

2) monitoring, by an information node monitor the update from a distributed information node and stored context information;

3) indexing and retrieving, by a context retriever the stored context information;

4) providing services for the information node monitor and the context retriever through an interpreter;

5) using a related main body for self-adaptive management when change of a context is retrieved;

6) reasoning a high-level context according to the related main body in a cloud knowledge base; and

7) providing to an effector to act on the pervasive environment through a multi-agent communication system.

2. The architecture according to claim 1, wherein the architecture comprises: acquiring kernel support, opening an application interface and building a pervasive computing operating system prototype based on agents.

### DESCRIPTION OF DRAWINGS

FIG. 1 is a diagram of a pervasive computing operating system prototype based on agents.

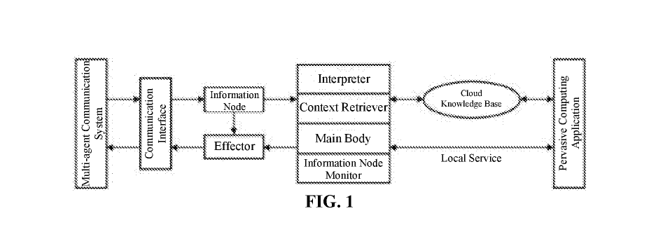

### DETAILED DESCRIPTION

A pervasive computing operating system prototype based on agents, comprising the following steps:

1) perceiving the change of a pervasive environment through an information node;

2) monitoring, by an information node monitor the update from a distributed information node and stored context information;

3) indexing and retrieving, by a context retriever the stored context information;

4) providing services for the information node monitor and the context retriever through an interpreter;

5) using a related main body for self-adaptive management when change of a context is retrieved;

6) reasoning a high-level context according to the related main body in a cloud knowledge base;

7) providing to an effector to act on the pervasive environment through a multi-agent communication system; and

8) acquiring kernel support, opening an application interface and building a pervasive computing operating system prototype based on agents.

1. A pervasive computing operating system architecture based on agents, comprising:
1) perceiving the change of a pervasive environment through an information node;
2) monitoring, by an information node monitor the update from a distributed information node and stored context information;
3) indexing and retrieving, by a context retriever the stored context information;
4) providing services for the information node monitor and the context retriever through an interpreter;
5) using a related main body for self-adaptive management when change of a context is retrieved;
6) reasoning a high-level context according to the related main body in a cloud knowledge base; and
7) providing to an effector to act on the pervasive environment through a multi-agent communication system.

2. The architecture according to claim 1, wherein the architecture comprises: acquiring kernel support, opening an application interface and building a pervasive computing operating system prototype based on agents.
